(19) United States
(12) Patent Application Publication
(10) Pub. No.: US 2010/0300420 A1
(43) Pub. Date: Dec. 2, 2010

(54) Precision Control of Operating Pressure for Pneumatic Guns

(76) Inventor: Daniel Robert Nelson, Redondo Beach, CA (US)

Correspondence Address: Daniel Nelson, 501 Esplanade, Apt. 304, Redondo Beach, CA, 90277, US

(21) Appl. No.: 12/475,568

(22) Filed: May 31, 2009

(51) Int. Cl. F41B 11/00; G01L 7/00

(52) U.S. Cl. 124/73; 73/700

(57) ABSTRACT

A pressure transducer or other means of measuring pressure inside a vessel is used to measure the pressure of a gas inside a pneumatic powered projectile gun. A valve is used to control the pressure inside the gun by controlling the amount of air entering from a compressed gas source at a higher pressure. Finally, a second valve is used to release the gas inside the gun into the barrel section, firing the projectile.

### REFERENCES CITED [REFERENCED BY]

U.S. Patent Documents

| | | |
|---|---|---|
| 5,913,303 | Jun. 22, 1999 | Kotsiopoulos |
| 6,003,504 | Dec. 21, 1999 | Rice, et al. |
| 6,705,036 | Mar. 16, 2004 | Orr |
| 6,763,822 | Jul. 20, 2004 | Styles |
| 7,237,544 | Jul. 3, 2007 | Jones |
| 7,258,114 | Aug. 21, 2007 | Rice |

### DESCRIPTION

### BACKGROUND OF THE INVENTION

The sport of paintball involves firing capsules filled with colored liquid at players using projectile guns powered by compressed gas (pneumatic). These projectile guns are usually fed from large tanks attached to the gun that hold a large volume of gas compressed to a high pressure (also known as the tank pressure). The tank pressure is usually higher then the pressure of the gas actually used by the gun to fire the projectile, called the operating pressure. Therefore, when the compressed gas is transferred from the tank to the gun, some device is usually used to reduce the pressure before it is used to fire the projectile. As the velocity of the projectile depends on the operating pressure of the gun, a constant operating pressure is desired to ensure each projectile is fired at the same velocity. Paintball guns are usually aimed by the user adjusting his aim based on the previous shot; therefore to achieve predictable shots and high accuracies, precise control of the operating pressure is critical.

Control of the operating pressure is normally done via a mechanical regulator that uses a spring and piston to allow the gas to expand as it travels from the tank to the paintball gun. The mechanical regulator is adjusted using a screw that adjusts the tension in the spring. While this method is effective at reducing the pressure of the gas from the tank, it does not allow for any way to precisely measure the operating pressure between each shot, therefore while shot velocities are controlled, there is no way to guarantee the velocity of each shot remains constant.

This invention seeks to allow such positive control of the operating pressure of a paintball gun, ensuring each shot is fired using the same pressure and guaranteeing the velocity of each projectile remains constant.

### SUMMARY OF THE INVENTION

This objective of this invention is to increase the accuracy of a pneumatic projectile gun by allowing positive control of the pressure of the gas used by the gun to fire a projectile (operating pressure), thus ensuring the velocity of each projectile fired remains constant. This is accomplished by using a pressure sensor connected to a controlling device that reads the pressure inside a storage chamber in the projectile gun. Once a preset limit is achieved, the controller closes a valve, sealing the storage chamber. The compressed gas inside the gun's storage chamber therefore remains at this controlled pressure until another valve is opened and the compressed gas released into the gun's firing chamber to fire the projectile. Once the projectile has exited the gun, the firing valve is closed, sealing the gun's storage chamber. The entry valve is then opened to allow compressed gas to enter the storage chamber, readying the gun to fire again. Any method can be used to control this cycle; while this patent describes an electronic method using a pressure transducer, solenoid valves and a microcontroller, a mechanical method could be used also.

### BRIEF DESCRIPTION OF THE DRAWINGS

FIG. 1 is a side view of the completed invention showing the storage chamber, the two valves and the pressure sensor. Also shown is the firing chamber of the projectile gun with the bolt. Not shown is the controlling device.

### DETAILED DESCRIPTION OF THE INVENTION

The pressure measurement sensor 1 is the primary feature of this invention that differentiates it from other pneumatic guns; no other paintball gun marketed yet uses any method of measuring internal pressure for use in controlling the velocity of the projectile. The pressure sensor 1 is connected to the storage chamber 4 and measures the internal pressure of storage chamber 4. The sensor 1 then sends the pressure reading to the marker's controller (not pictured). While a mechanical sensor and controller could be used, the simplest implementation of this invention is to use an electronic pressure sensor and a microcontroller.

The storage chamber 4 is sealed by the use of two valves, a firing valve 2 and an entry valve 3. Opening the entry valve 3 allows compressed air from the high pressure storage tank 7 to enter the gun's storage chamber 4. As storage tanks used for paintball are compressed to 700 psi to 4000 psi, the air entering the storage chamber 4 will be at a higher pressure then any air inside the storage chamber 4. Therefore, the longer the entry valve 3 is left open the higher the pressure inside the storage chamber 4 will be. This is the method this invention uses to control the operating pressure of the gun. The entry valve 3 is opened and closed by the gun's controller; once the controller reads that the correct pressure inside the storage chamber 4 has been reached, the controller closes the entry valve 3.

The firing valve 2 seals the storage chamber 4 from the firing chamber 5 and bolt 6. The firing valve 2 is also opened and closed by the controller. Once opened, the firing valve 2 allows the compressed gas inside the storage chamber 4 to enter the firing chamber 5 via the bolt 6. The exact method of how the bolt 6 is actuated is not in the scope of this invention; any method mechanical, pneumatic or other may be used.

For this invention, the controller is used to open and close the firing valve 2 and entry valve 3 and to read the pressure inside the storage chamber 4 via the pressure sensor 1. An electrical microcontroller would be the easiest type of controller to implement, however this patent covers any type of controller, mechanical or electrical. Some method is also required to allow the user to specify what the internal pressure inside the storage chamber 4 should be. This is how the user will adjust the firing velocity of the projectile; by setting a higher pressure the user will increase the velocity and vice versa.

The easiest implementation of this invention is to use an electronic microcontroller and integrate all of the gun's functions into this microcontroller. With this implementation, the entire firing sequence of a pneumatic gun using this invention is as follows: The user sends a signal to fire the projectile to the controller. The controller opens the firing valve 2, allowing the compressed gas inside the storage chamber to enter the bolt 6. The bolt 6 then channels the air to fire the projectile sitting in the firing chamber 5. After a preset time, the controller then closes firing valve 2 and opens the entry valve 3, allowing high pressure compressed gas to enter the storage chamber 4 from the high pressure storage tank via 7, thus pressurizing the storage chamber 4. While the storage chamber is being pressurized, the pressure sensor 1 reads the pressure and reports it to the controller. Once the pressure inside the storage chamber 4 reaches the pre-set limit, the controller closes the entry valve 3. Once the gun has been cocked with a new projectile in the firing chamber 5 and the storage chamber 4 has been pressurized, the firing cycle is complete and the gun is ready to fire again.

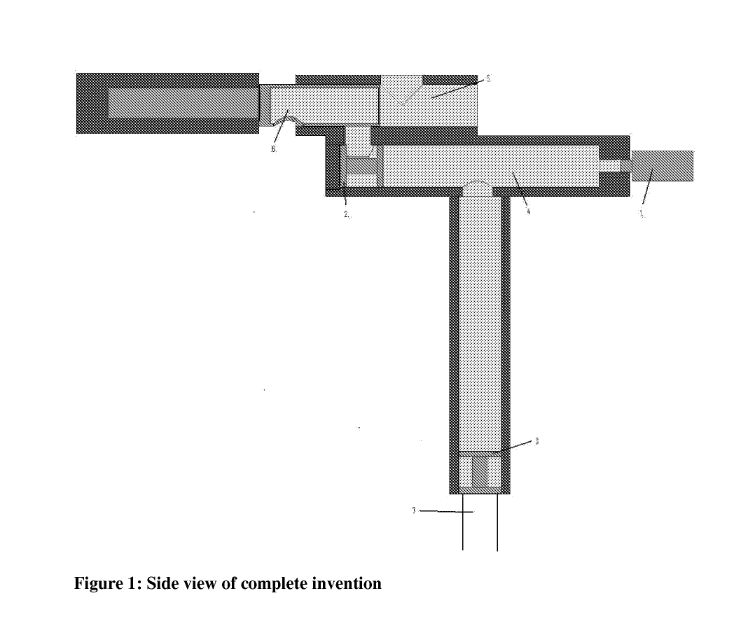

The configuration shown in FIG. 1 is one possible configuration that may be used for implementing this invention. The storage chamber 4 may be located anywhere on the gun depending on what type of cocking and firing mechanism is used, for aesthetic reasons, or for any other reason the designer chooses. Other possible configurations that could be used to implement this invention include placing the firing valve 2 directly behind the projectile and the firing chamber 5, thus eliminating the bolt 6.

1. A device for measuring the operating pressure of a pneumatic projectile gun

2. A device to allow compressed gas to enter a storage tank inside said pneumatic gun

3. A device to allow the compressed gas inside said pneumatic gun to enter the gun's barrel section, firing a projectile

4. A device to receive the pressure measurements from the device in claim 1. This device will also control the device in claim 2 in order to allow compressed gas into the gun's storage tank. This device will also control the device in claim 3 via user-inputted commands.
